(19) United States
(12) Patent Application Publication
(10) Pub. No.: US 2024/0244082 A1
(43) Pub. Date: Jul. 18, 2024

(54) SECURITY POSTURE VISUALIZATION

(71) Applicant: VMWARE, INC., Palo Alto, CA (US)

(72) Inventors: SHRINIVAS SHARAD PARASHAR, Pune (IN); Kalpesh PATEL, Pune (IN); Tarang KHANDELWAL, Pune (IN); Priyanka BALI, Pune (IN); Krishna Pavan VAIDYULA, Pune (IN)

(21) Appl. No.: 18/129,902

(22) Filed: Apr. 3, 2023

(30) Foreign Application Priority Data
Jan. 16, 2023 (IN) 202341003113

(51) Int. Cl. H04L 9/40

(52) U.S. Cl. CPC H04L 63/20

(57) ABSTRACT

The disclosure provides an approach for visualizing a security posture of a network entity. Embodiments include a method including displaying, on a display of a computing device, a security posture summary screen of a network entity. The method further includes receiving a first input on a first connection depicted in the security posture summary screen, the first connection between the network entity and a first entity of one or more source entities or one or more destination entities. The method further includes in response to the first input, displaying, on the display, a drill down view screen of first security rules applicable to communication between the network entity and the first entity.

### RELATED APPLICATIONS

Benefit is claimed under 35 U.S.C. 119(a)-(d) to Foreign application Ser. No. 20/234,1003113 filed in India entitled “SECURITY POSTURE VISUALIZATION”, on Jan. 16, 2023, by VMware, Inc., which is herein incorporated in its entirety by reference for all purposes.

### BACKGROUND

A data center implementing a software defined networking (SDN) environment may comprise a plurality of hosts in communication over a physical network infrastructure. Each host is a physical computer (machine) that may run one or more workloads, such as virtualized endpoints such as virtual machines (VMs), containers, and/or other virtual computing instances (VCIs). In some cases, VCIs are connected to software-defined networks (SDNs), also referred to herein as logical overlay networks, which may span multiple hosts and are decoupled from the underlying physical network infrastructure. Some SDN environments may further span multiple data centers, and may be referred to as multi-site networking environments.

It is often useful to define groups of entities (also referred to as network entities) in an SDN environment for use in applying policies, such as security policies (e.g., each policy including one or more firewall rules, one or more malware prevention policies, one or more intrusion detection policies, one or more intrusion prevention policies, etc.), to the groups, such as within and/or across different data centers. The groups may be referred to as security groups. Entities in a group may include, for example, physical machines, workloads, services, other networking objects, or even other groups, and/or the like, as further discussed herein. Accordingly, if a policy is applied to a group, then the policy may be automatically applied to each entity that is a member of the group automatically, and potentially across multiple data centers, thereby simplifying the process of applying policies to entities.

In some cases, an entity may be a member of multiple groups. Further, different security policies may be applied to different groups, and there may be a large number of security policies, as a given group may have one or more security policies applied. Accordingly, the effective security posture of an entity is based on the effect of the security policies applied to the one or more groups that entity is a part of. Further, where there are multiple security policies applied to the one or more groups of the entity, the effective security posture is based on the priority order of the security policies, such as the priority order of firewall rules of the security policies. For example, where there is conflict between different firewall rules applied to the same entity, the highest priority firewall rule may govern. Accordingly, due to the scale of policies, and entities potentially being part of multiple groups, understanding, monitoring, and troubleshooting the security posture of an entity can be complex.

### BRIEF DESCRIPTION OF THE DRAWINGS

FIG. 1 depicts example physical and virtual network components with which embodiments of the present disclosure may be implemented.

FIGS. 2-15 illustrate example screens of a security posture graphical user interface (GUI).

FIG. 16 depicts example operations related to functioning of a security posture GUI.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for simplifying the understanding and troubleshooting of the security posture of an entity, also referred to as a network entity. The security posture of an entity, as discussed, is based on the set of security polices applied to the entity and the priority order of the security policies, such as the firewall rules defined in the security policies. In an example, a security policy defines one or more firewall rules. A firewall rule may indicate, for example, that certain packets are to be allowed, dropped, or rejected, such as based on one or more of a source address (e.g., IP address), destination address, source port, destination port, and/or protocol of the packet, such as indicated in one or more headers of the packet. For example, an “allow” firewall rule indicates that packets, such as L3 or L2 traffic, meeting the requirements of the rule (e.g., having the specified source, destination, and/or protocol) are allowed to pass through the current firewall context, such as the switch, router, gateway, and/or the like, implementing the firewall. In another example, a “drop” firewall rule indicates that packets meeting the requirements of the rule are not allowed to pass through the current firewall context and are silently dropped, meaning no notification that the packet is not passed is generated.

Dropping a packet may cause the connection to be retried, such as by a source of the packet, until a number of retries threshold or time limit threshold is reached. In another example, a “reject” firewall rule indicates that packets meeting the requirements of the rule are not allowed to pass through the current firewall context, like a drop, but a destination unreachable messages is sent to a source of the packet. For example, if the protocol for the packet is transmission control packet (TCP), a TCP reset (RST) message is sent by the firewall context. In another example, if the packet is a user datagram protocol (UDP), internet control message protocol (ICMP), or internet protocol (IP) packet, an ICMP message with administratively prohibited code is sent by the firewall context. One benefit of a reject rule over a drop rule, is that the source of the packet is notified after only one attempt that the connection cannot be established, so overhead for retries to establish the connection can be eliminated.

It should be noted that though certain examples discussed herein are with respect to firewall rules defined by security policies, and the types of rules being allow, drop, and reject, the examples herein may similarly be used for other security policies, defining different types of rules that may be visualized in a similar manner. Further, though certain aspects are discussed with respect to an SDN, the techniques herein are similarly applicable to machines communicating over only physical networks.

Certain aspects of the present disclosure provide an improved graphic user interface (GUI) for visualizing the security posture of one or more entities. For example, in certain aspects, the GUI presents the incoming and outgoing connections or traffic of an entity from one or more other entities. In certain aspects, the GUI provides a summarized view of the security policies applied to an entity. In certain aspects, the GUI provides a drill-down view of the details of security policies applied to an entity. The improved GUI provides a technical improvement over previous techniques for presenting electronic display of the security policies applied to an entity by allowing more information to be displayed in an organized manner and for allowing non-traditional arrangements of information to be performed automatically. In particular, by focusing on automatically grouping entities together based on specific parameters, and providing specific techniques for automatically summarizing information, while still allowing to electronically drill- down on information to provide details, the techniques herein provide for an improved GUI. Further, the electronic interactive nature of the GUI means that it necessarily tied to a computing device and can therefore be only performed on a computing device, and not as a mental process.

In certain aspects, a group manager may enable the definition of groups of entities. For instance, a group may be a security group that is used to combine a plurality of entities for the purpose of defining security policies that are applicable to all of the entities together (e.g., rules restricting communication between members of a first group and members of a second group, limiting access by members of a given group to endpoints outside of a local network, and/or the like). Entities in a group may include, for example, workloads (e.g., VCIs), physical machines, other groups, services, and/or networking objects such as logical switches and logical ports. A networking object may be a logical construct in an SDN environment that implements functions related to operation of the network, such as connecting VCIs together or facilitating communication between VCIs, or a physical networking device, such as a router, switch, gateway, etc. A networking object that is a logical construct may itself be implemented as one or more VCIs. Logical switches, for example, create logical broadcast domains or segments to which an application or VM can be logically wired. Logical ports provides logical connection points to various types of destinations, such as logical switches, logical routers, and external networks. Logical switches, logical routers, etc., may be implemented on one or more physical devices as one or more virtual switches, virtual routers, etc., as is known in the art. For example, any arbitrary set of VMs in a datacenter may be placed in communication across a logical Layer 2 network by connecting them to a logical switch. Each logical switch corresponds to a virtual network identifier (VNI). A logical switch is collectively implemented by at least one virtual switch on each host that has a VM connected to the logical switch. The virtual switch on each host operates as a managed edge switch implemented in software by the hypervisor on each host. A service may be an application running on a physical machine, in a VCI, distributed across multiple physical machines and/or VCIs, and/or the like, such as in a network application layer and above, that performs a particular function. Example functions include data storage, manipulation, presentation, communication, and/or the like. Example services include Domain Name System (DNS) and Dynamic Host Configuration Protocol (DHCP).

A data center generally refers to a centralized facility where computers, network, storage, and other equipment that support operations of an organization reside. While data centers are generally physical facilities comprising physical host computers connected over a physical networking infrastructure, a data center may also be a software-defined data center that abstracts physical resources of computing devices. In certain aspects, any networks internal to a given data center are isolated from any networks outside the data center, in that any communication between devices with a data center and devices outside the data center, such as in another data center) occur via one or more gateways associated with the data center. Accordingly, each data center may have one or more respective gateways for communications between the data center and network locations outside of the data center.

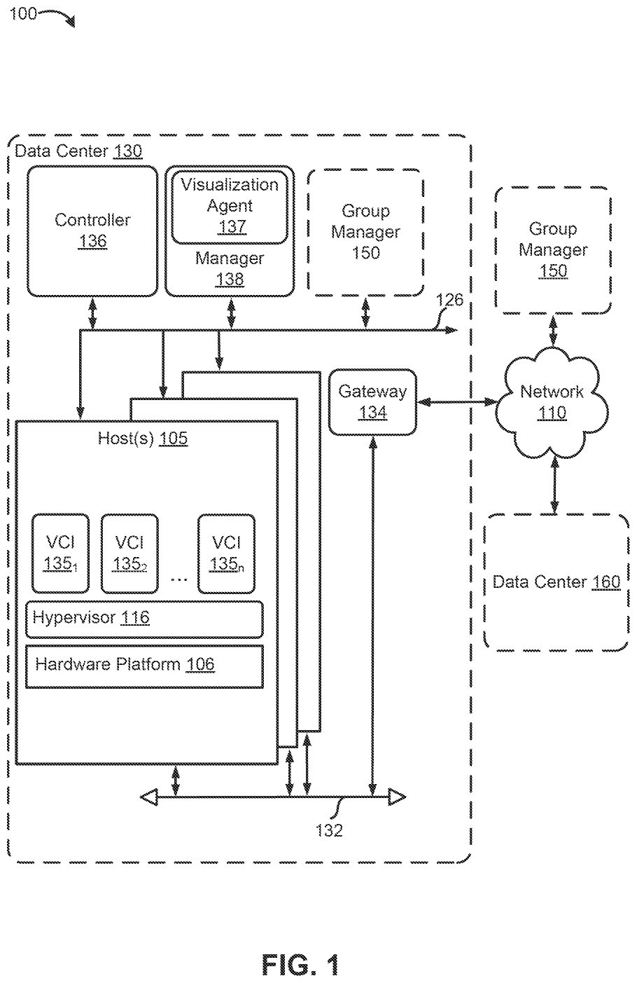

FIG. 1 depicts example physical and virtual network components with which embodiments of the present disclosure may be implemented.

Networking environment 100 includes data center 130 and optionally data center 160 and a group manager 150 connected to network 110 or alternatively management network 126. Network 110 is generally representative of a network of machines such as a local area network (“LAN”) or a wide area network (“WAN”), a network of networks, such as the Internet, or any connection over which data may be transmitted.

Each of data centers 130 and 160 generally represents a set of networked machines and may comprise a logical overlay network. Data center 160 may include similar components to those depicted in data center 130. Data center 130 includes host(s) 105, a gateway 134, a data network 132, which may be a Layer 3 network, and management network 126. Host(s) 105 may be an example of machines. Data network 132 and management network 126 may be separate physical networks or different virtual local area networks (VLANs) on the same physical network.

It is noted that, while not shown, additional data centers may also be connected to data center 130 and data center 160 via network 110. Communication between the different data centers may be performed via gateways associated with the different data centers.

Each of hosts 105 may include a server grade hardware platform 106, such as an x86 architecture platform. For example, hosts 105 may be geographically co-located servers on the same rack or on different racks. Host 105 is configured to provide a virtualization layer, also referred to as a hypervisor 116, that abstracts processor, memory, storage, and networking resources of hardware platform 106 for multiple virtual computing instances (VCIs) 135₁ to 135ₙ (collectively referred to as VCIs 135 and individually referred to as VCI 135) that run concurrently on the same host. VCIs 135 may include, for instance, VMs, containers, virtual appliances, and/or the like.

In certain aspects, hypervisor 116 may run in conjunction with an operating system (not shown) in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. In certain aspects, hypervisor 116 implements one or more logical entities, such as logical switches, routers, etc. as one or more virtual entities such as virtual switches, routers, etc. In some implementations, hypervisor 116 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Gateway 134 provides VCIs 135 and other components in data center 130 with connectivity to network 110, and is used to communicate with destinations external to data center 130. Gateway 134 may be implemented as one or more VCIs, physical devices, and/or software modules running within one or more hosts 105.

Controller 136 generally represents a control plane that manages configuration of VCIs 135 within data center 130. Controller 136 may be a computer program that resides and executes in a central server in data center 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of data center 130. Controller 136 communicates with hosts 105 via management network 126.

Manager 138 represents a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In one embodiment, manager 138 is a computer program that executes in a central server in networking environment 100, or alternatively, manager 138 may run in a VM, e.g. in one of hosts 105. Manager 138 is configured to receive inputs from an administrator or other entity, e.g., via a web interface or API, and carry out administrative tasks for data center 130, including centralized network management and providing an aggregated system view for a user. In some embodiments, manager 138 determines membership of groups, such as security groups, for data center 130 based on group definitions received from group manager 150.

Group manager 150 generally represents a management component for groups in data center 130 and optionally data center 160 (and, in some embodiments, additional data centers that are not shown). Group manager 150 may allow a user to define groups of entities in the networking environment and policies that reference those groups. In an example, global group manager 150 provides a user interface by which a user is able to indicate one or more conditions for membership in a group and define policies applicable to the group, such as security policies. A group definition may also specify the span of the group, indicating which data centers in the networking environment the group is to be implemented on.

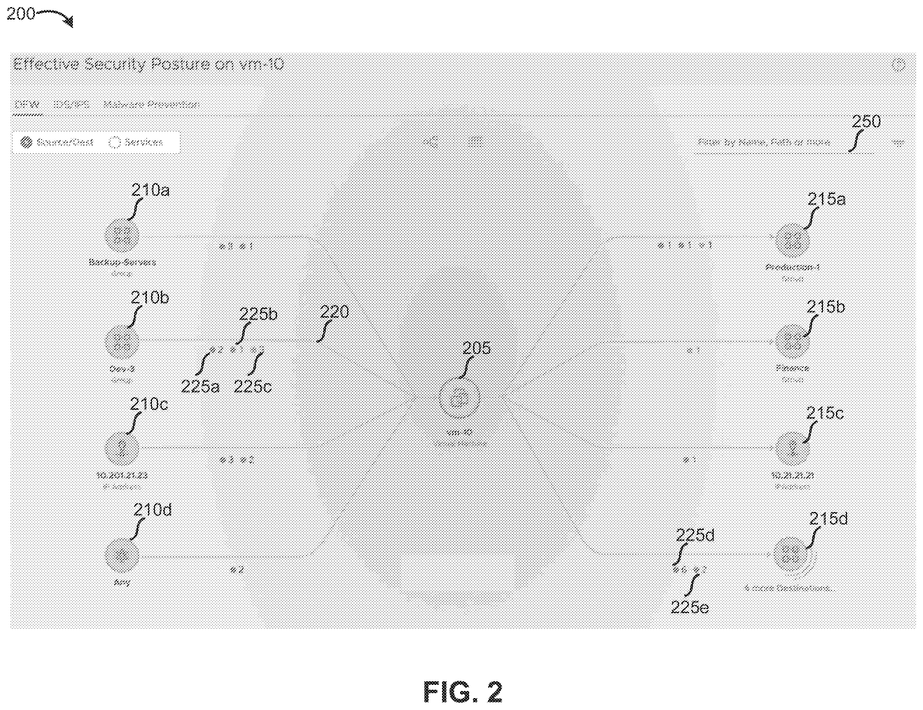

Visualization agent 137 is a process shown running in manager 138, though it may run in any suitable VCI or physical device communicatively coupled to host(s) 105. Visualization agent 137 is configured to receive information, such as from manager 138 and/or controller 136, regarding entities, the information including group membership information of entities indicating to which group(s) entities in networking environment 100 belong, security policy information of groups indicating for each group, which security polices apply to the group as well as the security policy itself (e.g., firewall rule). Visualization agent 137 is configured to use this information to present a security posture GUI of entities to a user, such as through display on a monitor or other display of a computing device. Details of the security GUI, including examples of how data is presented and how the GUI functions when interacted with are described further herein with respect to FIGS. 2-16.

FIG. 2 illustrates a screen 200 of an example security posture GUI presented on a display of a computing device, accordingly to certain aspects. Screen 200 may be referred to as a source/destination security posture summary screen for an entity. As shown, screen 200 illustrates an entity 205, in this example a VM, for which the security posture is displayed. Screen 200 illustrates a high level security posture of entity 205 with respect to sources entities 210a-210d shown on a first side (e.g., left side) of entity 205, and destination entities 215a-215d shown on a second side (e.g., right side) of entity 205. Each of source entities 210a-210d is an entity for which entity 205 has at least one security policy applied (e.g., based on group membership of entity 205), such as where the security policy applies to traffic having a source entity 210 as a source of the packet and entity 205 as a destination of the packet. Each of destination entities 215a-215d is an entity for which entity 205 has at least one security policy applied (e.g., based on group membership of entity 205), such as where the security policy applies to traffic having entity 205 as a source of the packet and a destination entity 215 as a destination of the packet.

In the example of screen 200, the source entities 210a-210d are sources of packets sent to entity 205 and the destination entities 215a-215d are destinations of packets sent from entity 205. In the example, the sources of packets and destinations of packets may be suitable entities such as a group, a static IP address, or ANY (e.g., a group corresponding to any and all sources of packets for entity 205).

A corresponding separate line 220 couples each source entity 210 and destination entity 215 to entity 205. Each line 220 represents a connection of the source entity 210 or destination entity 215 with entity 205. It should be noted that a connection may not necessarily represent a direct network connection, and may represent a connection that passes through any number of networks, switches, gateways, routers, proxies, and/or the like.

Further, adjacent to each line 220 are shown one or more security policy summaries 225. For example, each security policy summary 225 may indicate a number of rules of a given type applicable between the entities connected by the line 220. For example, security policy summary 225a indicates a number of ALLOW firewall rules applied between source entity 210b and entity 205. Further, security policy summary 225b indicates a number of DROP firewall rules applied between source entity 210b and entity 205. Security policy summary 225c indicates a number of REJECT firewall rules applied between source entity 210b and entity 205.

Accordingly, screen 200 provides an automatic, efficient, and useful way to visualize a summary of security policies applied to an entity at a high level. Even when there is limited display space on a computer screen to display the information.

In certain aspects, in order to avoid clutter in screen 200, and to improve visualization based on the limited space available on a computing screen, all source entities and/or destination entities of entity 205 with applicable security policies may not be shown in screen 200 and the same time. For example, a threshold number (e.g., four in this example) of source/destination entities may be set, and if there are more source/destination entities than the threshold number, multiple source/destination entities may be combined together and shown as a single icon. For example, entity 215d is shown as a combination of four destination entities, as indicated by the label “4 more Destinations.” Further, the line 220 connecting entity 205 to entity 215d includes security policy summaries 225 that each summarize the sum of the number of rules of the given type applied across the combination of destination entities corresponding to entity 215d. For example, security policy summary 225d indicates a number of ALLOW firewall rules applied between any of the destination entities represented by destination entity 215d and entity 205. Further, security policy summary 225b indicates a number of DROP firewall rules applied between any of the destination entities represented by destination entity 215d and entity 205.

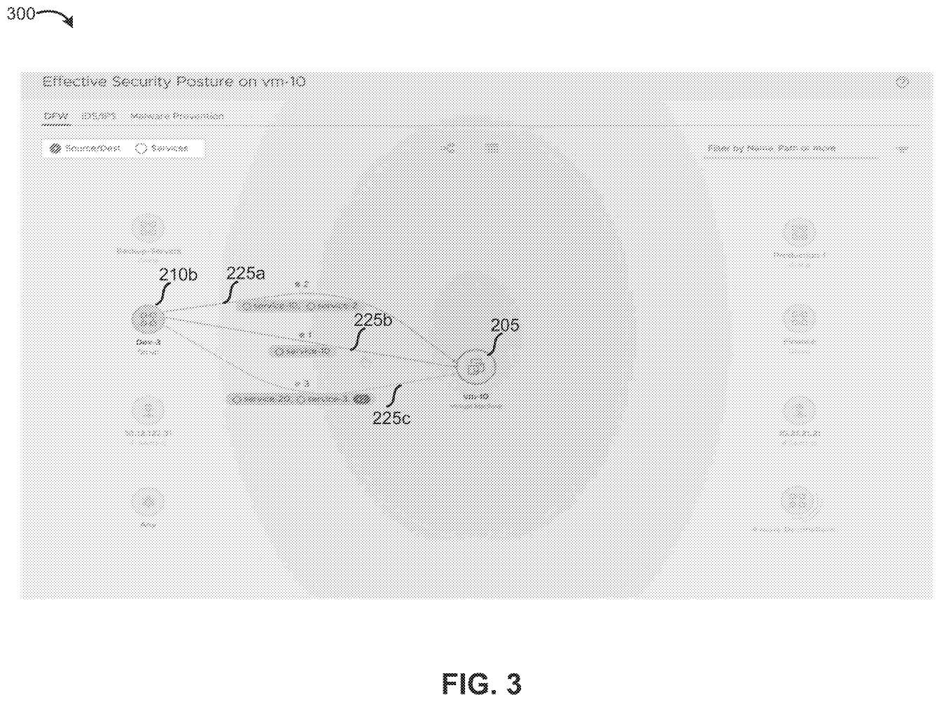

In certain aspects, hovering a cursor or providing an appropriate input over a line 220 causes a quick view screen of security posture GUI to be displayed which provides additional details about the security policy summaries 225 associated with the line 220. For example, FIG. 3 illustrates an example quick view screen 300, which may be displayed when hovering a cursor over line 220 between source entity 210b and entity 205. As shown, each of security policy summaries 225a-225c is expanded and shown as a separate line between source entity 210b and entity 205.

Further, in quick view screen 300, for each of security policy summaries 225a-225c, along with displaying the number of rules, the services to which each rule corresponds is shown. For example, security policy summary 225a indicates that there are two ALLOW firewall rules applied, including for packets from source service-10 and for packets from source service-2. It should be noted that the number of rules may not equal the number of services, as a rule can implicate more than one service. Security policy summary 225b indicates that there is one DROP firewall rule applied for packets from source service-10. Security policy summary 225c indicates that there are three REJECT firewall rules applied, including for packets from source service-10, source service-3, and 2 additional services. The services indicated are services running on one or more workloads corresponding to source entity 210b, shown as a group.

In certain aspects, such as shown with respect to security policy summary 225c, in the quick view screen 300, all services corresponding to the security policy summary 225c may not be shown to avoid clutter, meaning the display may be compacted. In certain aspects, a threshold number of services (e.g., in this example 2) may be shown in security policy summary 225c, and an indication (e.g., in this example “+2”) of the number of additional services not shown on quick view screen 300 is displayed. In certain aspects, clicking on the indication of the number of additional services displays the names of the additional services not shown.

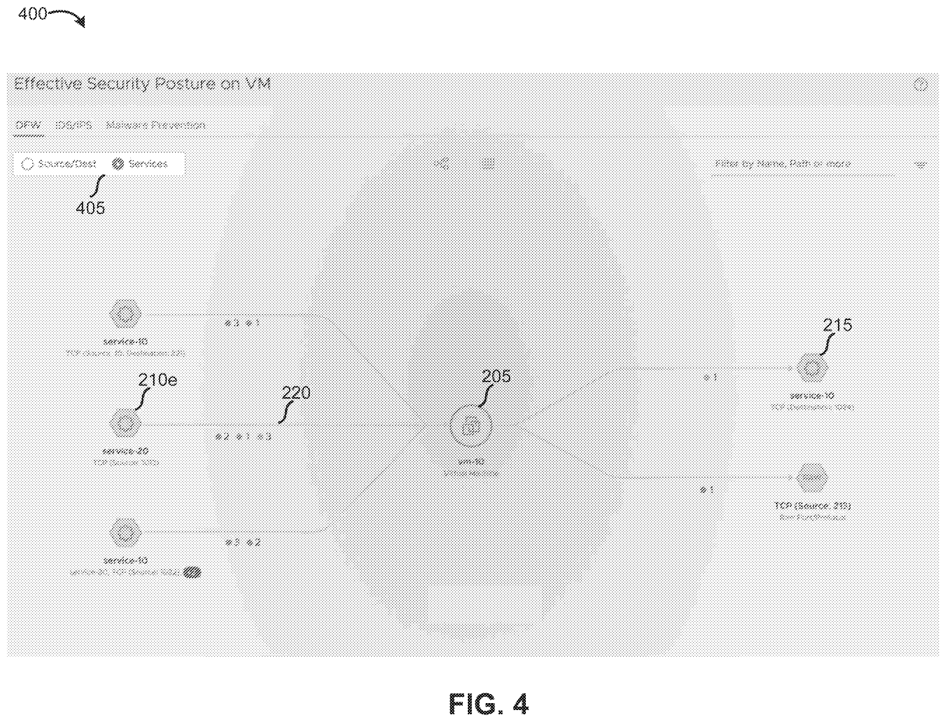

FIG. 4 illustrates a screen 400 of an example security posture GUI presented on a display of a computing device, accordingly to certain aspects. Screen 400 may be referred to as a service security posture summary screen for an entity. Screen 400 is similar to screen 200, except that the source and destination entities shown are services, instead of groups or static IP addresses. In certain aspects, a toggle 405 is provided in security posture GUI to select between a service security posture summary screen for an entity, such as screen 400, and a source/destination security posture summary screen for an entity, such as screen 200.

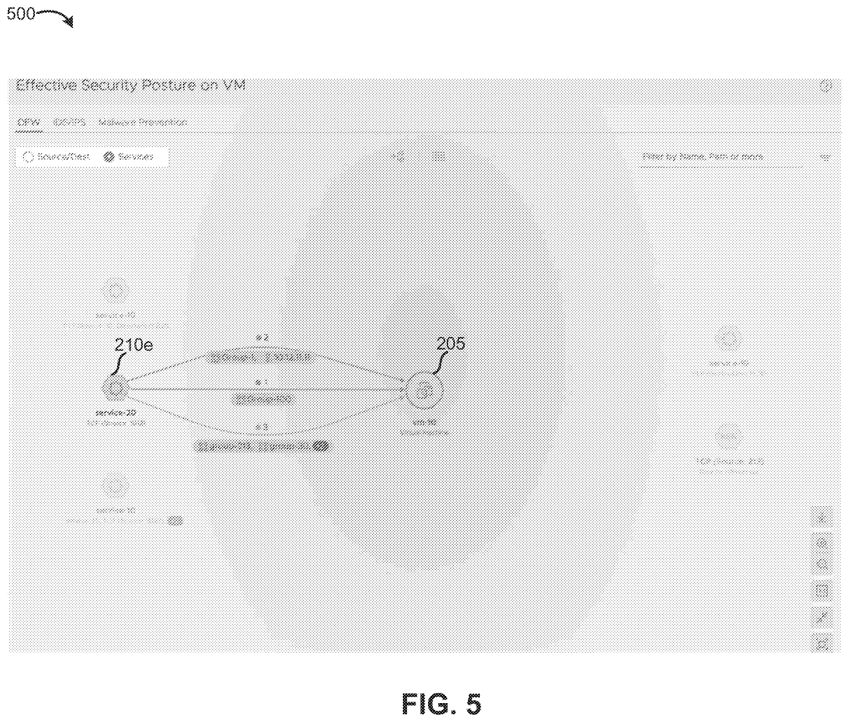

FIG. 5 illustrates an example quick view screen 500, which may be displayed when hovering a cursor over line 220 between source entity 210e and entity 205. Quick view screen 500 may be similar to quick view screen 300 and displayed based on a similar action as discussed with respect to screen 200, but instead applied to screen 400. As shown, the expanded security policy summary information in quick view screen 500 indicates similar information as shown in quick view screen 300, however, instead of which services are associated with a particular security policy summary 225 being displayed, an indication of the groups or static IPs that implement the service and are associated with the particular security policy summary 225 are displayed.

In certain aspects, providing a suitable input, such as clicking, on a particular line 220 or other line between a source/destination entity and entity 205, in screen 200, screen 300, screen 400, or screen 500, causes the security GUI to provide a drill down view that provides detailed information about the security policies, and in particular rules defined in the security policies, applied for the connections between the source/destination entity and entity 205. For example, clicking on line 220 between source entity 210b and entity 205 in screen 200 causes the security GUI to display drill down view screen 600.

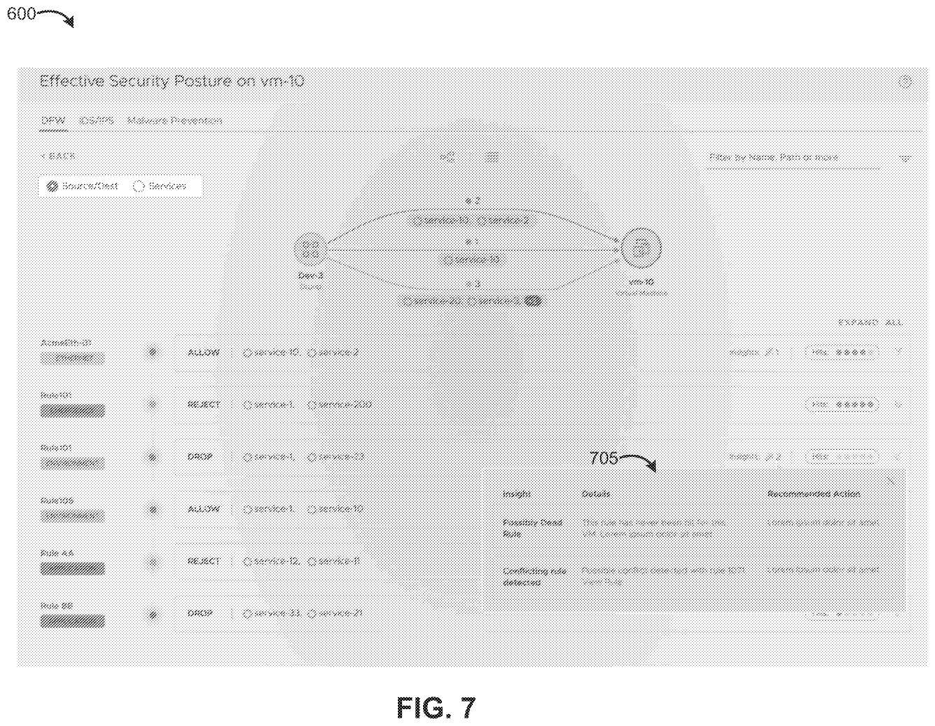

Screen 600 includes (e.g., at the top) a visual summary display 605, which displays similar information as quick view screen 300 for security policies applied between source entity 210b and entity 205. Additionally, screen 600 includes a list 610, which lists, in sequential priority order, such as highest priority at the top and lowest priority at the bottom, all of the rules defined in security policies applied between source entity 210b and entity 205. Within the list 610, details of each of the rules are provided. It should be noted that the details for a given rule shown in screen 600 are an example, and that fewer or additional details may be shown. For example, rule 615, labeled “AcmeEth-01”, is an Ethernet firewall rule as shown. The rule 615 is an ALLOW type firewall rule, that is applied to services service-10 and service-2 as shown. Details of the rule may be shown such as the rule ID of 1077, that the rule is defined in a security policy labeled ethRulesPolicy, the entity or group the rule is applied to (here DFW), that the rule has been successfully applied between source entity 210b and entity 205, a total rule hit count shown as 445 indicating how many times the rule has been applied to packets, an entity specific rule hit count shown as 421 indicating how many times the rule has been applied to packets destined for entity 205 in particular, a last hit time for entity 205 indicating the last time the rule has been applied to a packet for entity 205, and a last modified time indicating the last time the rule was modified and by whom. The details of list 610 may be collapsible, such as shown in screen 600 in FIG. 7.

Screen 600 also includes, for some rules, an insights item, such as insights item 620 of rule 617. As shown, a number of insights associated with the rule is shown. For insights item 620, the number of insights is two. Insights may include details associated with the rule such as whether the rule is a dead rule, meaning it will never be used, such as if a conflicting rule with higher priority is also applied. For example, if a first rule indicates to allow traffic for a first service, and a second rule indicates to drop traffic for the first service, but the first rule has a higher priority than the second rule, than the second rule will never be used and is a dead rule. Another type of insight may indicate a duplicate rule, such as if two of the same rule are defined. An appropriate input on item 620, such as hovering a cursor or clicking, causes an insights pop-up box 705 to be displayed, such as shown in FIG. 7. As shown, the insights pop-up box 705 indicates details of the insights for the associated rule. In this example, the insights pop-up box 705 indicates the rule is possibly a dead rule, provides the details as to why that is assumed, and provides a recommended action. The insights pop-up box 705 further indicates that a rule conflicting with the rule has been detected, provides the details as to the conflicting rule and a link to view the rule, and provides a recommended action.

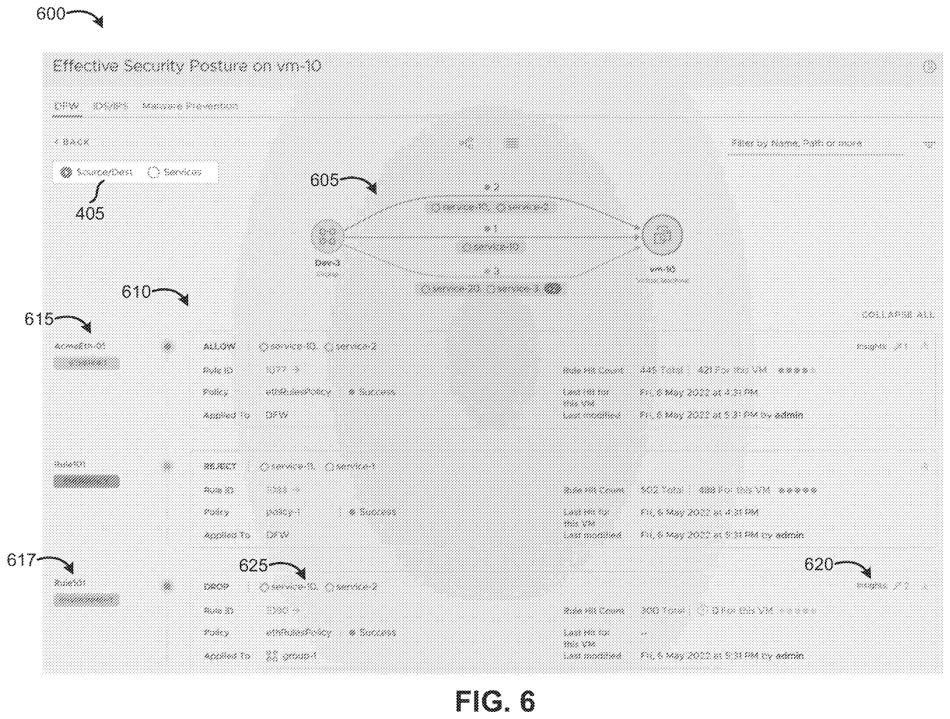

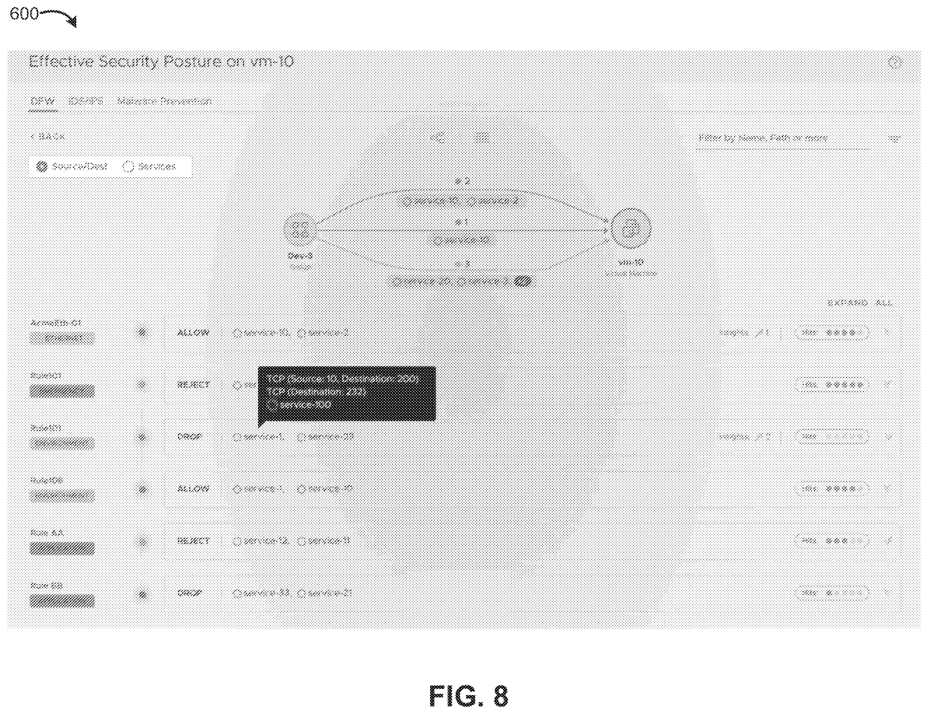

Further, in certain aspects, providing an appropriate input, such as hovering or clicking, on a service identified in a rule, such as service 625 identified in rule 617 in FIG. 6, causes a service information pop-up box 804 to be displayed, such as shown in FIG. 8. As shown, the service information pop-up box 804 displays details about the service, such as a protocol, source port, destination port, etc.

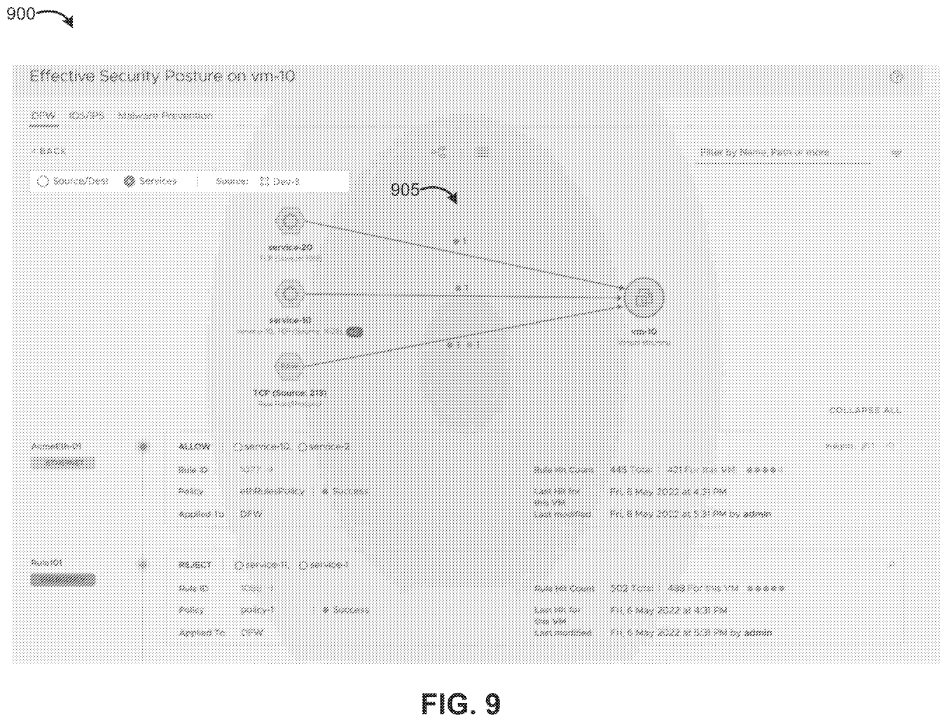

Further, as shown in FIG. 6, screen 600 also includes toggle 405 to switch between a services view and a source/destination view of the drill down view. For example, screen 600 illustrates a source/destination view of the drill down view. Drill down view screen 900 of FIG. 9 illustrates a services view of the drill down view, similar to screen 600. However, in contrast to screen 600, the visual summary display 905, displays similar information as quick view screen 500 for security policies applied between a service and entity 205.

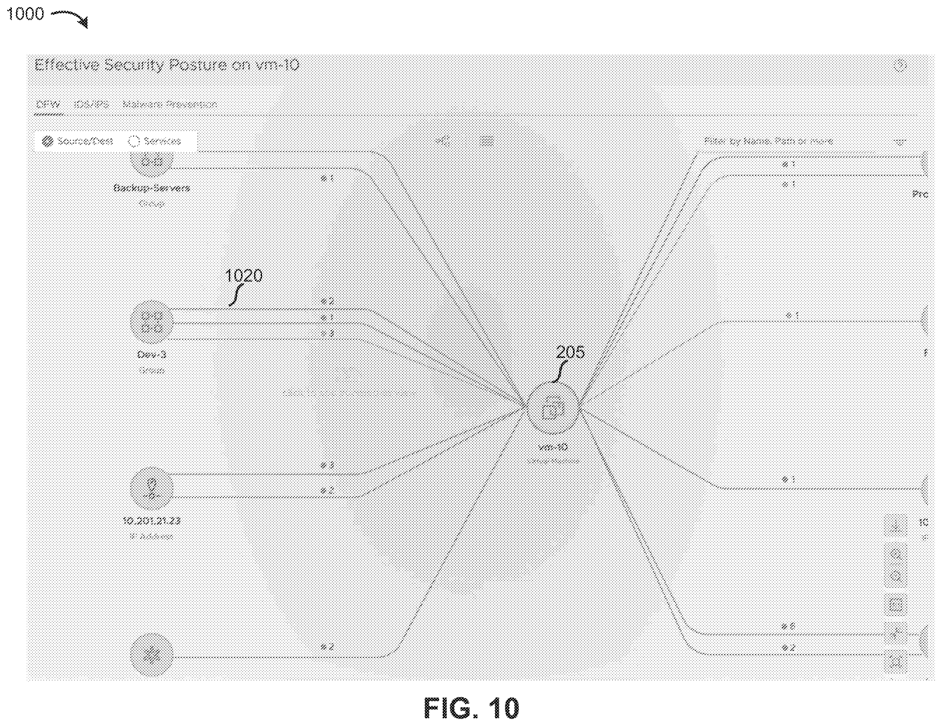

In certain aspects, the security posture GUI is configured to present a zoom-in view of a security policy summary 225. For example, by providing an appropriate input on or near a line 220, such as in screen 200 of FIG. 2, a zoom-in view of security policies 225a-225c is shown such as shown in zoom-in view screen 1000 of FIG. 10. For example, where the display device displaying the screen 200 includes a touch screen, a user may pinch-to-zoom on or near line 220, to cause the security posture GUI to display zoom-in view screen 1000. Zoom-in view screen 1000 may separate out the different rule types between each source/destination entity and entity 205 into separate lines 1020 as shown, so that rule counts are grouped by type.

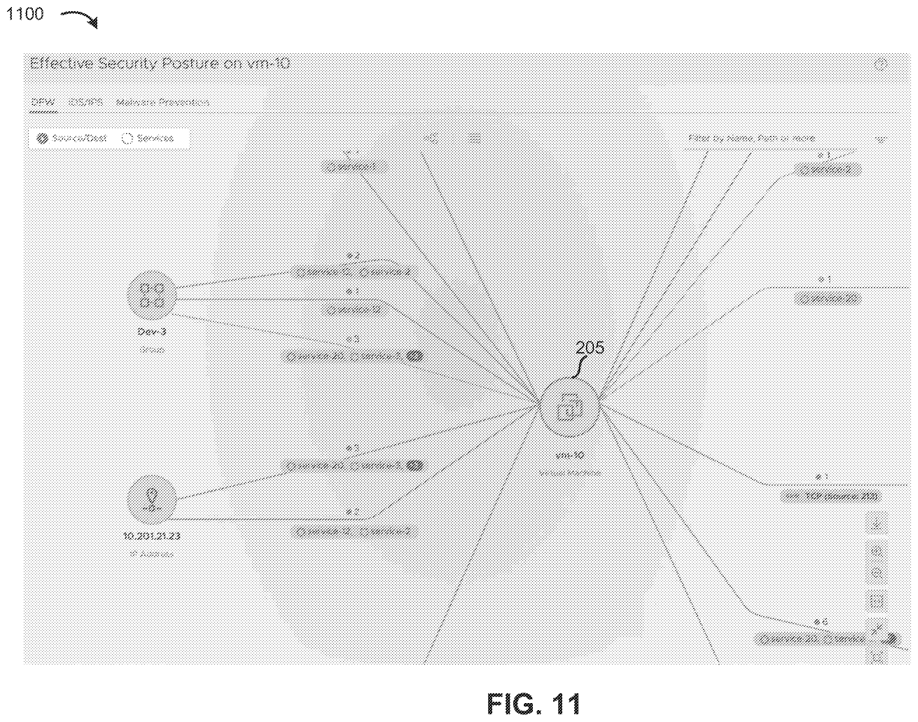

In certain aspects, a user can provide an appropriate input, such as a further pinch-to-zoom on or near the lines 1020, to present a detailed zoom-in view screen 1100, as shown in FIG. 11. The detailed zoom-in view screen 1100 may provide similar information as quick view screen 300 or quick view screen 500, but for each connection shown between source/destination entities and entity 205.

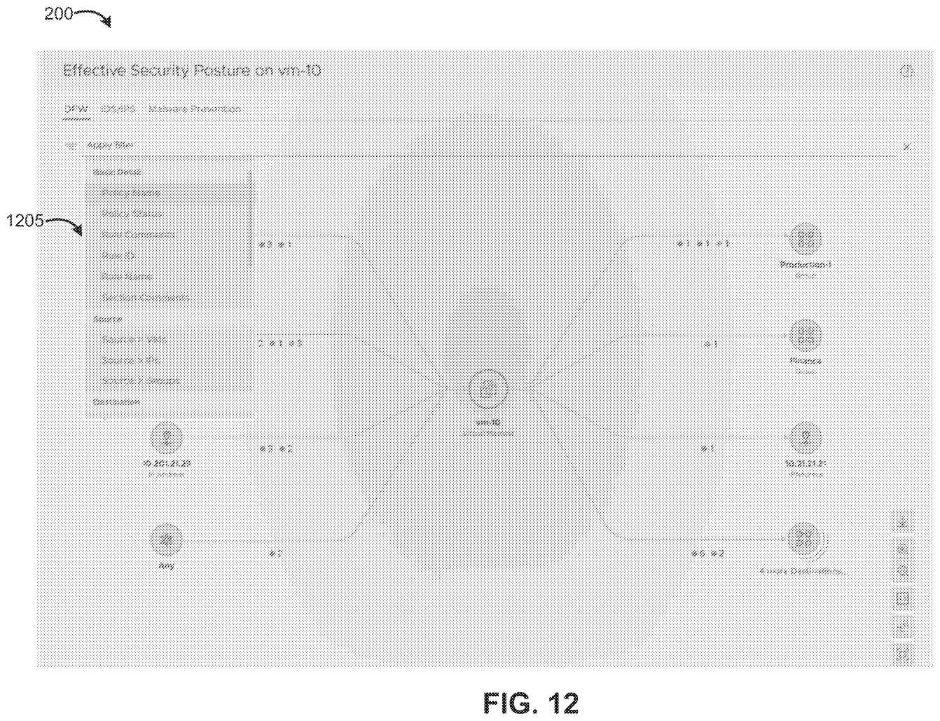

In certain aspects, security posture GUI also provides a filter function, to filter information displayed within security posture GUI. For example, as shown in screen 200 of FIG. 2, a filter application field 250 is illustrated. Providing appropriate input on the field 250, such as hovering or clicking, may bring up a filter menu 1205, such as shown in FIG. 12. Filter menu 1205 includes different selectable types of filters that can be used to filter information displayed within security posture GUI. One or more filter types may be selected, and one or more parameters may be specified for each of the selected one or more filter types, such as through input on a keyboard, or other input. Though certain filter types are shown, additional or fewer filter types may be available. For example, the policy name filter may cause only information associated with specified one or more policies to be displayed. The policy name status filter may cause only information associated with policies with the one or more specified policy statuses to be displayed. Other example filter types include rule comments filters, rule ID filters, rule name filters, section comment filters, source VM filters, source IP filters, source group filters, and/or the like.

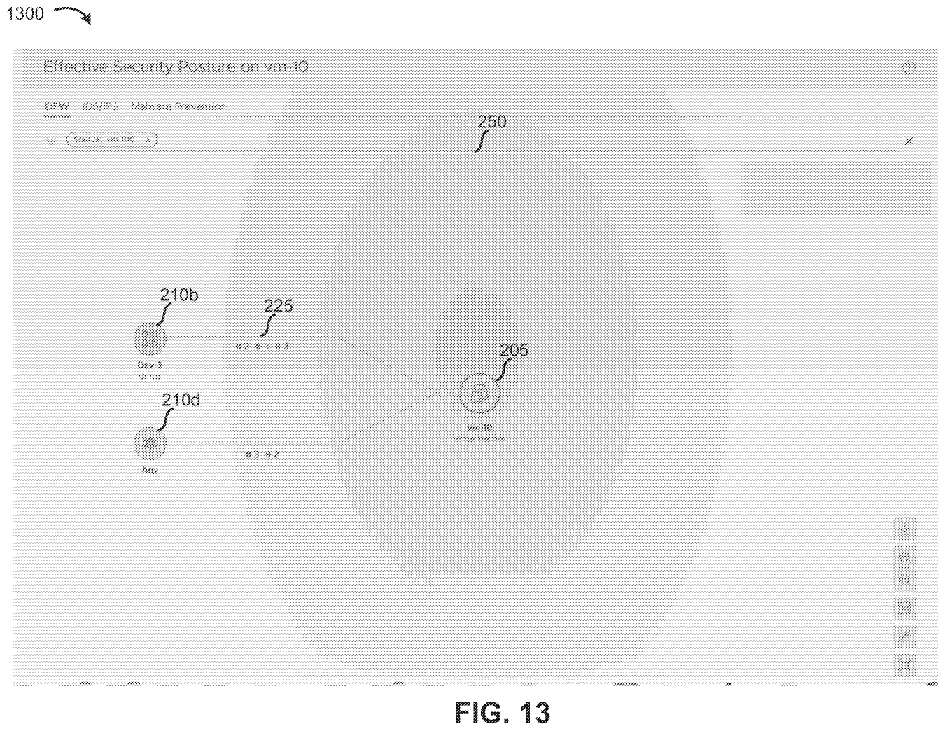

For example, filtered source/destination security posture summary screen 1300 shown in FIG. 13 represents a filtered version of screen 200 of FIG. 2. In particular, as shown in field 250 of screen 1300, the filter applied is for source VM being VM-100. Accordingly, the only source/destination entities shown in screen 1300 as compared to screen 200 are source entity 210b and source entity 210d, as each of these source entities include VM-100 as a source, but the remaining source/destination entities shown in screen 200 do not. Further, in certain aspects, the security policy summary information 225 shown in screen 1300 may also only pertain to rules applicable to VM-100.

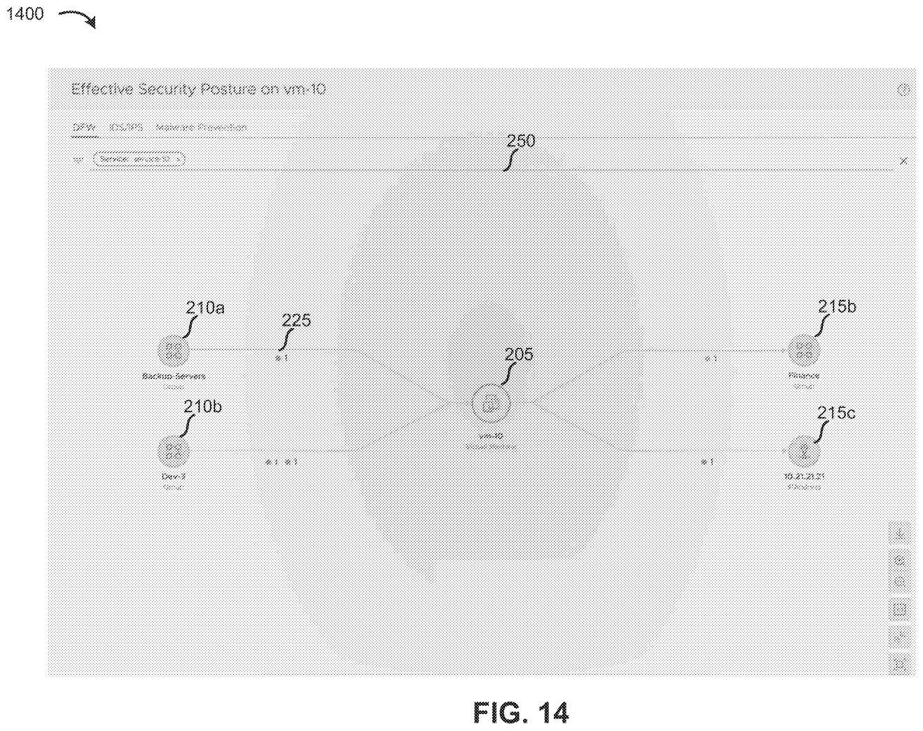

As another example, filtered source/destination security posture summary screen 1400 shown in FIG. 14 represents a different filtered version of screen 200 of FIG. 2. In particular, as shown in field 250 of screen 1400, the filter applied is for a service being service-10. Accordingly, the only source/destination entities shown in screen 1400 as compared to screen 200 are source entity 210a, source entity 210b, destination entity 215b, and destination entity 215c, as each of these entities runs service-10, but the remaining source/destination entities shown in screen 200 do not. Further, in certain aspects, the security policy summary information 225 shown in screen 1400 may also only pertain to rules applicable to service-10.

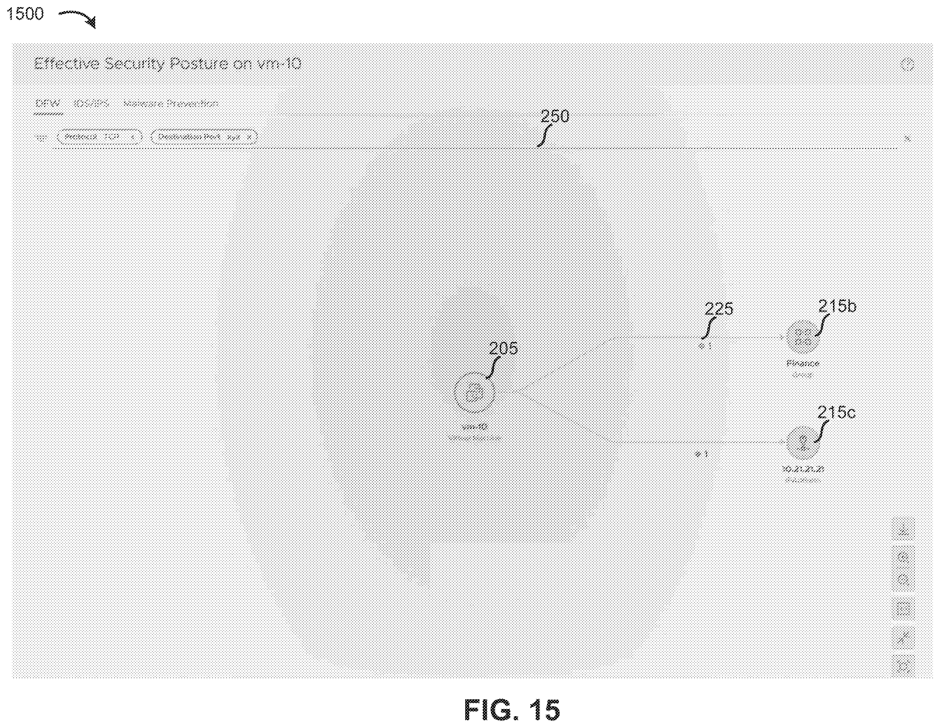

As another example, filtered source/destination security posture summary screen 1500 shown in FIG. 15 represents a different filtered version of screen 200 of FIG. 2. In particular, as shown in field 250 of screen 1500, the filter applied is for a protocol being TCP and a destination port being xyz. Accordingly, the only source/destination entities shown in screen 1500 as compared to screen 200 are destination entity 215b and destination entity 215c, as each of these entities has at least one TCP connection with entity 205 on port xyz, but the remaining source/destination entities shown in screen 200 do not. Further, in certain aspects, the security policy summary information 225 shown in screen 1500 may also only pertain to rules applicable to TCP connections on port xyz.

The following are some specific examples of how the functioning of the security posture GUI, according to embodiments discussed herein, may help to solve various technical problems in the field of computer network security.

In one example, an administrator may need to identify the types of network traffic that are allowed or denied for a particular entity. For example, for a web server, and administrator, using the security posture GUI, can quickly confirm that only hypertext transfer protocol (HTTP) traffic is allowed and other types of traffic is blocked by applying a filter on field 250 of screen 200 to filter on the service being HTTP and selecting the service view from toggle 405, to check that the only service allowed is for a web server.

In another example, a user can identify if packets of a particular protocol are being dropped for a particular entity 205. For example, a user can check if HTTP traffic is being dropped at port 80 by applying a filter on field 250 of screen 200 to filter on the service being HTTP and the port being 80 and selecting the source/destination view from toggle 405, to check which entities the policy is applied to.

In another example, a user can identify if a particular type of traffic is allowed inbound to or outbound from a particular entity 205. For example, a user can check if DNS protocol is allowed by applying a filter on field 250 of screen 200 to filter on the service being DNS and selecting the services view from toggle 405, to check if the DNS service is shown on the screen and is allowed.

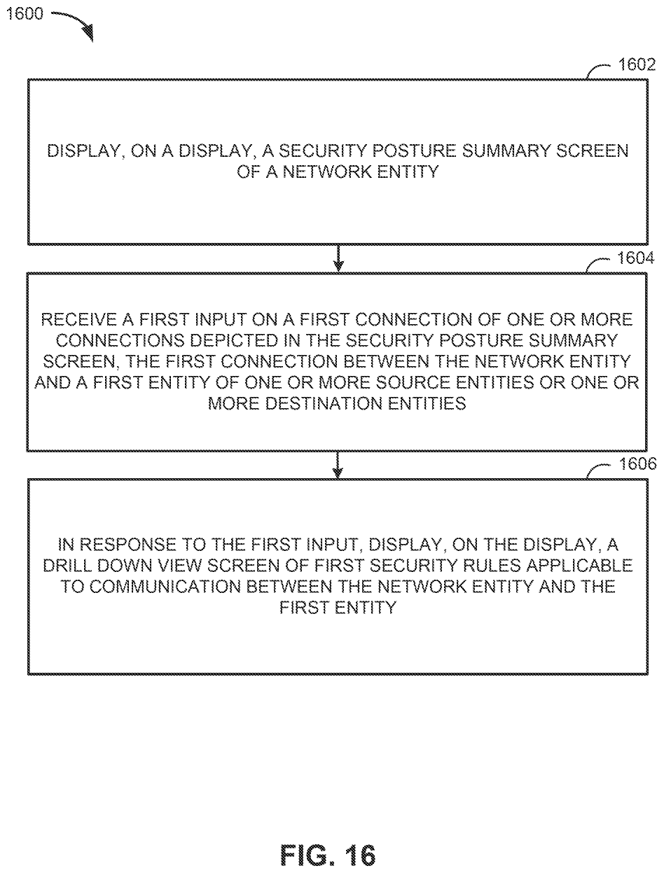

FIG. 16 depicts example operations 1600 related to functioning of a security posture GUI as may be performed by visualization agent 137.

At step 1602, a security posture summary screen of a network entity is displayed in a display of a computing device, such as a computing device used to access manager 138. The security posture summary screen includes a depiction of the network entity and a depiction of one or more source entities or one or more destination entities. The security posture summary screen further includes a depiction of one or more connections between the one or more source entities or one or more destination entities and the network entity. The security posture summary screen further includes, for each of the one or more connections, a depiction of a number of security rules, for each of one or more types of rules, applicable to communication between the network entity and the corresponding source entity or destination entity.

At step 1604, a first input is received on a first connection of the one or more connections, the first connection between the network entity and a first entity of the one or more source entities or one or more destination entities. For example, the first input may be received from the computing device used to access manager 138.

At step 1606, in response to the first input, a drill down view screen of first security rules applicable to communication between the network entity and the first entity is displayed on the computing device. The drill down view screen includes a list of the first security rules arranged in priority order. The drill down view screen further includes one or more details about each security rule of the first security rules.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) --CD-ROM, a CD-R,or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions.

Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of visualizing a security posture of a network entity, comprising:
displaying, on a display of a computing device, a security posture summary screen of a network entity, the security posture summary screen comprising:
a depiction of the network entity;
a depiction of one or more source entities or one or more destination entities;
a depiction of one or more connections between the one or more source entities or one or more destination entities and the network entity;
for each of the one or more connections, a depiction of a number of security rules, for each of one or more types of rules, applicable to communication between the network entity and the corresponding source entity or destination entity;
receiving a first input on a first connection of the one or more connections, the first connection between the network entity and a first entity of the one or more source entities or one or more destination entities; and
in response to the first input, displaying, on the display, a drill down view screen of first security rules applicable to communication between the network entity and the first entity, the drill down view screen comprising:
a list of the first security rules arranged in priority order; and
one or more details about each security rule of the first security rules.

2. The method of claim 1, further comprising:
receiving a filter parameter in a filter field of the security posture summary screen; and
in response to the receiving the filter parameter, displaying a filtered security posture summary screen of the network entity, the filtered security posture summary screen comprising:
a depiction of the network entity; and
a depiction of a subset of the one or more source entities or one or more destination entities, wherein the subset includes any of the one or more source entities or one or more destination entities that have a same parameter as the filter parameter;

3. The method of claim 2, wherein the filter parameter specifies one or more of a policy name, a policy status, a rule comment, a rule identifier, a rule name, a second comment, a source entity name, a source IP address, or a source group.

4. The method of claim 1, wherein for at least one security rule of the first security rules, the one or more details comprises an insights item indicating one or more of whether the rule is possibly a dead rule or a duplicate rule.

5. The method of claim 1, wherein the security posture summary screen comprises a toggle for toggling between depicting entities as services and depicting entities as groups or static IP addresses.

6. The method of claim 1, wherein the network entity comprises a virtual computing instance, and wherein each of the one or more source entities or one or more destination entities comprise at least one of a static IP address, a security group, or a service application.

7. The method of claim 1, further comprising:
receiving a second input on the first connection of the one or more connections; and
in response to the second input, displaying, on the display, a quick view screen of the first security rules, the quick view screen comprising:
a depiction of the number of security rules, for each of the one or more types of rules, applicable to communication between the network entity and the first entity; and
for each of the one or more types of rules, a depiction of one or more services to which a security rule of the number of security rules applies.

8. A computing system comprising:
memory; and
at least one processor coupled to the memory, the at least one processor configured to:
display, on a display, a security posture summary screen of a network entity, the security posture summary screen comprising:
a depiction of the network entity;
a depiction of one or more source entities or one or more destination entities;
a depiction of one or more connections between the one or more source entities or one or more destination entities and the network entity;
for each of the one or more connections, a depiction of a number of security rules, for each of one or more types of rules, applicable to communication between the network entity and the corresponding source entity or destination entity;
receive a first input on a first connection of the one or more connections, the first connection between the network entity and a first entity of the one or more source entities or one or more destination entities; and
in response to the first input, display, on the display, a drill down view screen of first security rules applicable to communication between the network entity and the first entity, the drill down view screen comprising:
a list of the first security rules arranged in priority order; and
one or more details about each security rule of the first security rules.

9. The computing system of claim 8, wherein the at least one processor is further configured to:
receive a filter parameter in a filter field of the security posture summary screen; and
in response to the receiving the filter parameter, display a filtered security posture summary screen of the network entity, the filtered security posture summary screen comprising:
a depiction of the network entity; and
a depiction of a subset of the one or more source entities or one or more destination entities, wherein the subset includes any of the one or more source entities or one or more destination entities that have a same parameter as the filter parameter;

10. The computing system of claim 9, wherein the filter parameter specifies one or more of a policy name, a policy status, a rule comment, a rule identifier, a rule name, a second comment, a source entity name, a source IP address, or a source group.

11. The computing system of claim 8, wherein for at least one security rule of the first security rules, the one or more details comprises an insights item indicating one or more of whether the rule is possibly a dead rule or a duplicate rule.

12. The computing system of claim 8, wherein the security posture summary screen comprises a toggle for toggling between depicting entities as services and depicting entities as groups or static IP addresses.

13. The computing system of claim 8, wherein the network entity comprises a virtual computing instance, and wherein each of the one or more source entities or one or more destination entities comprise at least one of a static IP address, a security group, or a service application.

14. The computing system of claim 8, wherein the at least one processor is further configured to:
receive a second input on the first connection of the one or more connections; and
in response to the second input, display, on the display, a quick view screen of the first security rules, the quick view screen comprising:
a depiction of the number of security rules, for each of the one or more types of rules, applicable to communication between the network entity and the first entity; and
for each of the one or more types of rules, a depiction of one or more services to which a security rule of the number of security rules applies.

15. A non-transitory computer readable media storing instructions, that when executed by a computer system, causes the computer system to perform operations for visualizing a security posture of a network entity, the operations comprising:
displaying, on a display, a security posture summary screen of a network entity, the security posture summary screen comprising:
a depiction of the network entity;
a depiction of one or more source entities or one or more destination entities;
a depiction of one or more connections between the one or more source entities or one or more destination entities and the network entity;
for each of the one or more connections, a depiction of a number of security rules, for each of one or more types of rules, applicable to communication between the network entity and the corresponding source entity or destination entity;
receiving a first input on a first connection of the one or more connections, the first connection between the network entity and a first entity of the one or more source entities or one or more destination entities; and
in response to the first input, displaying, on the display, a drill down view screen of first security rules applicable to communication between the network entity and the first entity, the drill down view screen comprising:
a list of the first security rules arranged in priority order; and
one or more details about each security rule of the first security rules.

16. The non-transitory computer readable media of claim 15, wherein the operations further comprise:
receiving a filter parameter in a filter field of the security posture summary screen; and
in response to the receiving the filter parameter, displaying a filtered security posture summary screen of the network entity, the filtered security posture summary screen comprising:
a depiction of the network entity; and
a depiction of a subset of the one or more source entities or one or more destination entities, wherein the subset includes any of the one or more source entities or one or more destination entities that have a same parameter as the filter parameter;

17. The non-transitory computer readable media of claim 16, wherein the filter parameter specifies one or more of a policy name, a policy status, a rule comment, a rule identifier, a rule name, a second comment, a source entity name, a source IP address, or a source group.

18. The non-transitory computer readable media of claim 15, wherein for at least one security rule of the first security rules, the one or more details comprises an insights item indicating one or more of whether the rule is possibly a dead rule or a duplicate rule.

19. The non-transitory computer readable media of claim 15, wherein the security posture summary screen comprises a toggle for toggling between depicting entities as services and depicting entities as groups or static IP addresses.

20. The non-transitory computer readable media of claim 15, wherein the network entity comprises a virtual computing instance, and wherein each of the one or more source entities or one or more destination entities comprise at least one of a static IP address, a security group, or a service application.
